(19) United States
(12) Patent Application Publication
(10) Pub. No.: US 2011/0175839 A1
(43) Pub. Date: Jul. 21, 2011

(54) USER INTERFACE FOR A MULTI-POINT TOUCH SENSITIVE DEVICE

(75) Inventor: Sudhir Muroor Prabhu, Bangalore (IN)

(73) Assignee: Koninklijke Philips Electronics N.V., Eindhoven (NL)

(21) Appl. No.: 13/119,533

(22) PCT Filed: Sep. 17, 2009
(86) PCT No.: PCT/IB09/54065

§ 371 Date: Mar. 17, 2011

(30) Foreign Application Priority Data
Sep. 24, 2008 (EP) 08164970.9

(51) Int. Cl. G06F 3/041

(52) U.S. Cl. 345/173

(57) ABSTRACT

A user interface unit (13) to interpret signals from a multi-point touch sensitive device (3) is disclosed. The user interface unit (13) comprises a gesture unit (13a) configured to enable a user to touch at least one item of data using a finger and select the at least one item of data, hold at least two fingers in contact with the at least one selected item of data and stretch the two fingers apart to view information about the at least one selected item of data while the two fingers are held apart and in contact with the user interface unit (13) and to no longer view the information about the selected item of data in response to releasing the at least two fingers held apart in contact with the user interface unit (13). This is generally useful in devices that display content in a list and each item of the list has associated metadata.

### FIELD OF THE INVENTION

The present subject matter relates to a user interface for a multi-point touch sensitive device that enables a user to select an item and obtain information on the selected item.

### BACKGROUND OF THE INVENTION

US 2007/0152984 discloses a portable communication device with multi-touch input. The disclosed device can detect one or more multi-touch contacts and motions and can perform one or more operations on an object based on the one or more multi-touch contacts and/or motions. The disclosed device generally involves multiple user interactions to enable/disable information display of the selected object which can be tedious.

### SUMMARY OF THE INVENTION

Accordingly, the present subject matter preferably seeks to mitigate, alleviate or eliminate one or more of the above mentioned disadvantages singly or in combination. In particular, it may be seen as an object of the present subject matter to provide a user interface that can allow users to view information corresponding to the selected object with minimal user interactions. The invention is defined by the independent claims. The dependent claims define advantageous embodiments.

This object and several other objects are obtained in a first aspect of the present subject matter by providing a user interface unit to interpret signals from a multi-point touch sensitive device. The user interface unit comprises a gesture unit configured to detect whether a user touches the multi-point touch sensitive device at a location where a data item is displayed so as to select the data item, detect whether the user holds at least two fingers in contact with the multi-point touch sensitive device at the location where the data item is displayed, and to detect whether the user stretches the two fingers apart so as to view information about the data item while the two fingers are held apart and in contact with the multi-point touch sensitive device, and detect whether the user ceases to have the two fingers held apart and in contact with the multi-point touch sensitive device so as to no longer view the information about the data item.

Generally, in hand held devices, the content is displayed as a list. The content has associated metadata (additional information). Metadata is herein understood as data being descriptive of the content of the associated data and which can be ordered in different categories such as song titles, artist name, for music files or sender and receiver received in case of mail exchange data. As an illustrative example, in a windows explorer application, the files can be listed and each file generally has metadata information such as file owner, file size, file creation date and file modification date. When the user is browsing through the entire list and when the user selects the item of his/her choice, the user would like to view the details of the selected item. This may require multiple interactions to be performed on the selected item.

Generally an approach used to display the information of the selected item is based on certain time out. The information about the selected item is displayed as a drop down menu over the selected item. As an illustrative example, when mouse is used as a user interface, the pointer is pointed on a particular item and after a certain time out the metadata information is displayed. When the user tries to move to the next item, the drop down menu is removed and the focus is moved to the next item. This mechanism forces the user to wait for the time out which may not be desirable.

In another approach, a contextual options menu is generally provided which can be enabled by a menu key. The user has to select the information option from the plurality of options, to get the relevant information on the selected item. To remove the information menu, the user has to press the menu key again or wait for the time out. This can involve multiple user interactions.

Both the above mentioned approaches involve multiple user interactions and can be tedious. In the disclosed user interface unit, once the user has selected an item, the user can appropriately stretch his fingers and hold on to the user interface unit and view the required information corresponding to the selected item. Hence, the number of user interactions can be minimized.

The disclosed user interface unit has the following advantages:

i. It can reduce the number of user interactions
ii. It can remove the interaction with the options menu to select the “information” option to view the metadata details

The gesture unit is configured to detect stretching of the at least two fingers apart and holding the at least two fingers in contact with the user interface unit. This allows the user to appropriately space the fingers apart and obtain required information on the selected item of data.

The gesture unit is further configured to detect the separation of the at least two fingers in contact with the user interface unit after the two fingers is stretched apart. This is advantageous in retrieving corresponding information from the volatile or non volatile memory based on the amount of separation of the at least two fingers in contact with the user interface unit after the two fingers is stretched apart.

In a still further embodiment, the gesture unit is configured such that the maximum allowable separation distance between the at least two fingers corresponds to the complete information available about the data item and detecting the user stretching the at least two fingers apart in relation to the maximum allowable separation distance and holding on to the user interface unit allows viewing proportionate part of the information corresponding to the data item, the maximum allowable separation distance being determined based on the size of the user interface unit. This has the advantage that it can provide a sneak peek mechanism to help the user to view the necessary data based on the separation distance between the at least two fingers. Further, the stretching of the two fingers can be controlled suitably to display the relevant information and full separation can provide the complete information corresponding to the selected item of data.

In a still further embodiment, the gesture unit is further configured such that stretching the at least two fingers apart around 50% of the maximum allowable separation distance allows proportionate viewing of around 50% of the complete available information corresponding to the at least one selected item of data.

In a second aspect of the present subject matter, a method of providing a user interface unit to interpret signals from a multi-point touch sensitive device is disclosed. The method comprises:

enabling a user to touch at least one item of data using a finger and select the at least one item of data; and

allowing the user to hold at least two fingers in contact with the at least one selected item of data and stretch the two fingers apart to view information about the at least one selected item of data while the two fingers are held apart and in contact with the user interface unit and to no longer view the information about the selected item of data in response to releasing the at least two fingers held apart in contact with the user interface unit.

In an embodiment of the method, the method is configured such that the maximum allowable separation distance between the two fingers corresponds to the complete available information about the selected item of data and stretching the at least two fingers apart in relation to the maximum allowable separation distance and holding on to the user interface unit allows viewing proportionate part of the information corresponding to the at least one selected item of data, the maximum allowable separation distance being determined based on the size of the user interface unit.

### BRIEF DESCRIPTION OF THE DRAWINGS

These and other aspects, features and advantages will be further explained by the following description, by way of example only, with reference to the accompanying drawings, in which same reference numerals indicate same or similar parts, and in which:

FIG. 1 schematically represents an example of a front plan view of a portable media player;

FIG. 2 is a schematic diagram illustrating several components of the portable media player in accordance with an embodiment of the present invention;

FIG. 3 is an illustration of multi-point touch sensitive input to the portable media player provided by two fingers;

FIG. 4 is a first example of a screen view comprised in a menu provided by the portable media player's multi-point touch sensitive input;

FIG. 5 is a second example of a screen view;

FIG. 6 is a third example of a screen view; and

FIG. 7 is a simple flowchart illustrating steps of the method of providing a user interface unit according to an embodiment of the present invention.

### DETAILED DESCRIPTION OF THE EMBODIMENTS

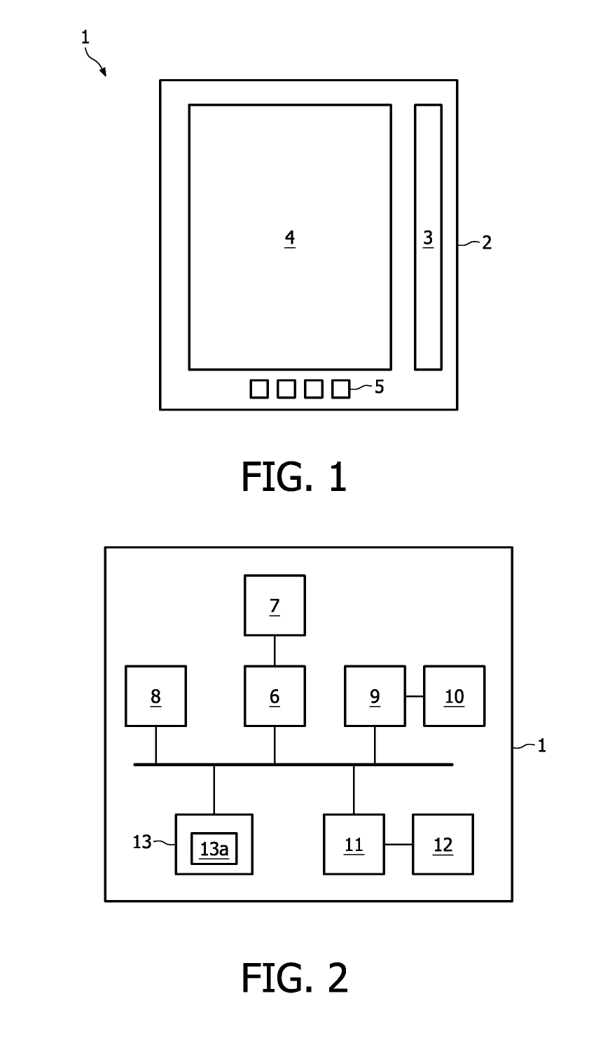

Referring now to FIG. 1, the portable media player 1 comprises

1. a housing 2

2. a multi-point touch sensitive strip 3

3. a screen 4 of a display device

4. keys 5 (optional) as means for providing user input.

Alternative configurations are possible as well. For example, the multi-point touch sensitive strip 3 may be located vertically below the screen 4.

Referring now to FIG. 2, the portable media player 1 is provided with a data processor 6 and working memory 7. The data processor 6 controls the operation of the portable media player 1 by executing instructions stored in non-volatile memory 8. The non-volatile memory 8 comprises any one or more of a solid-state memory device, an optical disk, a magnetic hard disk etc.

As an example, audio files are stored in the non-volatile memory 8. An audio decoder 9 decompresses and/or decodes a digital signal comprised in a music file. Sound comes to the user by means of an audio output stage 10.

A graphics processor 11 and display driver 12 provide signals controlling the display device having the screen 4. An user interface unit 13 comprises a gesture unit 13a.

The gesture unit 13a interprets signals from the touch-sensitive strip 3 (cf. FIG. 1).

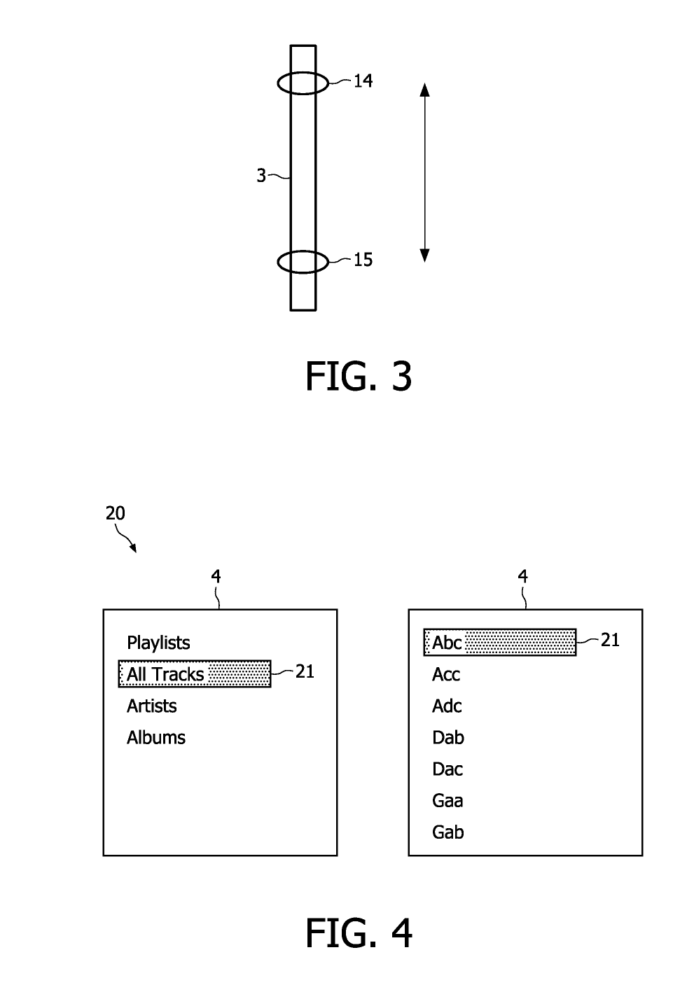

The touch-sensitive strip 3 (cf. FIG. 3) is of a multi-point type. It is capable of tracking at least two points of reference on the user's body e.g. two fingers held against the touch-sensitive strip 3 simultaneously. Tracking is carried out in one dimension, in that only positions 14, 15 along the length of the strip 3 are tracked. Reference numeral 14 indicates position 1 and reference numeral 15 indicates position 2. The arrow indicates the direction of movement of both the fingers. The portable media player 1 recognizes gestures conveyed through fingers moving along the strip 3. Movement of fingers along the strip 3 in opposite direction corresponds to an expansion gesture 17. In other words, outward movement is referred to as expansion gesture. The maximum allowable separation distance between the two fingers is determined based on the length of the multi-touch sensitive strip 3.

In an embodiment, the files corresponding to audio tracks stored in non-volatile memory 8 are stored in a flat hierarchy or at the same level in any file hierarchy maintained by the portable media player 1. Upon activation of e.g. one of the keys 5, a first screen view 20 is presented on the screen 4 as shown in FIG. 4. It corresponds to a menu of available options for displaying a list of audio tracks on the screen 4. In the menu section corresponding to the first screen view 20 a user may cause a selection bar 21 to move from item to item in the list, using the touch-sensitive strip 3.

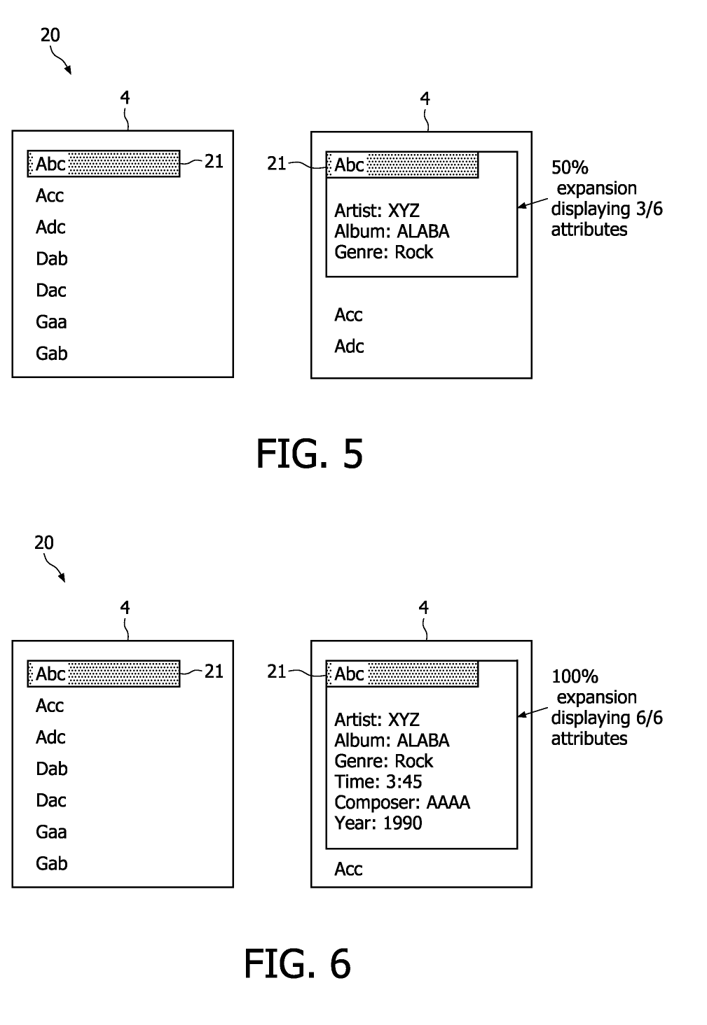

Referring now to FIG. 5, the user selects the first item (i.e. Abc) and the screen depicts the view transition from the list of all tracks with the focus on the first item. The tracks have six different attributes namely Artist, Album, Genre, Time, Composer and Year. The user selects the first item (i.e. Abc) using a finger. Subsequently, the user touches the first selected item (i.e. Abc) using two fingers. The fingers are stretched apart only about 50% of the maximum allowable separation distance. Hence, only 3 attributes (i.e. Artist, Album and Genre) out of the 6 attributes are proportionately displayed. FIG. 5 shows the transformed view representing the metadata information displayed triggered by stretching the two fingers apart (i.e. only 50% of the maximum allowable separation distance). When the user removes both the fingers from the user interface unit (i.e. upon breaking the finger touch contact with the user interface unit), the view returns to normal. Further, subsequent item in the list (i.e. Acc, Adc) can be displayed based on the availability of rendering space or the information attributes.

Referring now to FIG. 6, the first item is selected (i.e. Abc). The two fingers are stretched 100% apart. FIG. 6 shows the transformed view displaying the complete metadata information corresponding to the first item (i.e. Abc). All the 6 attributes namely Artist, Album, Genre, Time, Composer and Year are displayed corresponding to the item Abc. Further, subsequent item in the list is displayed (i.e. Acc) based on the availability of rendering space.

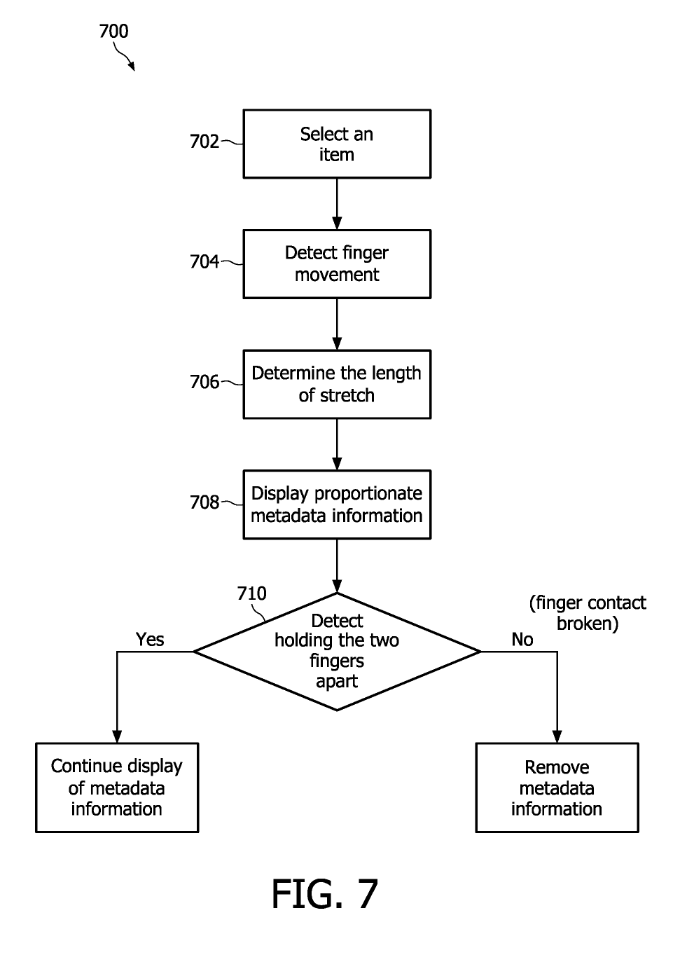

The methodology 700 of providing the user interface unit to interpret signals from a multi touch sensitive device is briefly illustrated in FIG. 7 which shows steps carried out by the data processor 6.

In step 702, the finger touch of a user is detected and the touched item of data is selected. In step 704, the finger movement in relation to the selected item of data is detected. In step 706, the stretching of the two fingers apart and holding the fingers on to the user interface unit is detected. Further, the length of the stretch or the separation distance between the fingers is determined. In step 708, on holding the stretched fingers apart, the data processor 6 retrieves corresponding proportionate metadata information corresponding to the selected item of data from for e.g. the volatile or non volatile memory. The proportionate metadata information is displayed on the screen 4 of the display device. In step 710, holding of the stretched fingers apart is detected and in case the stretched fingers are held apart the display of the proportionate metadata information is continued. In case the holding of the stretched fingers are released (i.e. the contact with the user interface unit is broken) the screen is refreshed thereby removing the metadata information.

The disclosed method can provide a sneak peek of the information of the selected item of data by allowing the user to stretch the two fingers and hold the two fingers apart and to no longer view the information corresponding to the selected item of data in response to releasing the fingers.

In general, the disclosed user interface unit can be configured to have the following features:

i. detect the expansion gesture i.e. stretching of the two fingers apart
ii. detect holding of both the fingers post expansion gesture
iii. detect the quantity of expansion as compared to the possible complete expansion and provide the expansion as a percentage.
iv. detect the release of the fingers post expansion gesture and refresh the information summary

Further, suitable software may be used that can be triggered based on the above inputs. The software itself can be made to detect the current focused item post expansion and hold gesture and retrieve corresponding information from the volatile or non-volatile memory. The software can use the percentage of the expansion and decide the corresponding percentage of information to be displayed. The software can also detect removing of the finger post expansion gesture and trigger the redraw to no longer view the information summary.

A few applications where the disclosed user interface unit can be used are listed below:

i. file browser
ii. inbox of a mail agent
iii. juke boxes
iv. message box of mobile phones
v. telephone contact book

In summary, a user interface unit to interpret signals from a multi-point touch sensitive device is disclosed. The user interface unit comprises a gesture unit configured to enable a user to touch at least one item of data using a finger and select the at least one item of data, hold at least two fingers in contact with the at least one selected item of data and stretch the two fingers apart to view information about the at least one selected item of data while the two fingers are held apart and in contact with the user interface unit and to no longer view the information about the selected item of data in response to releasing the at least two fingers held apart in contact with the user interface unit. This is generally useful in devices that display content in a list and each item of the list has associated metadata.

Although claims have been formulated in this application to particular combinations of features, it should be understood that the scope of the disclosure of the present subject matter also includes any novel features or any novel combination of features disclosed herein either explicitly or implicitly or any generalization thereof, whether or not is relates to the same subject matter as presently claimed in any claim and whether or not it mitigates any or all of the same technical problems as does the present subject matter.

Further, while the subject matter has been illustrated in detail in the drawings and foregoing description, such illustration and description are to be considered illustrative or exemplary and not restrictive; the subject matter is not limited to the disclosed embodiments. Other variations to the disclosed embodiments can be understood and effected by those skilled in the art of practicing the claimed subject matter, from a study of the drawings, the disclosure and the appended claims. As an example, an artifact similar to the touch sensitive strip 3 may be provided in an area of such a touch screen. In yet another alternative, the index finger may be used to select a data item, while movement of the middle finger triggers display of information about the data item, which movement of the middle finger is along a line that does not include the position of the index finger. So, in the claims, the expression “stretch apart” should be understood as covering any increase in the distance between the tops of two fingers. The invention is not limited to graphical user interfaces for portable media players, but may be used to browse lists of other data items, including those corresponding to functions or routines carried out by a computer device.

Use of the verb “comprise” and its conjugates does not exclude the presence of elements other than those stated in a claim or in the description. Use of the indefinite article “a” or “an” preceding an element or step does not exclude the presence of a plurality of such elements or steps. A single unit (e.g. a programmable device) may fulfill the functions of several items recited in the claims. The mere fact that certain measures are recited in mutually different dependent claims does not indicate that a combination of these measured cannot be used to advantage. The figures and description are to be regarded as illustrative only and do not limit the subject matter. Any reference sign in the claims should not be construed as limiting the scope.

1. A user interface unit (13) to interpret signals from a multi-point touch sensitive device (3), the user interface unit (13) comprising a gesture unit (13a) configured to
detect whether a user touches the multi-point touch sensitive device (3) at a location where a data item is displayed so as to select the data item,
detect whether the user holds at least two fingers in contact with the multi-point touch sensitive device (3) at the location where the data item is displayed, and to detect whether the user stretches the two fingers apart so as to view information about the data item while the two fingers are held apart and in contact with the multi-point touch sensitive device (3), and
detect whether the user ceases to have the two fingers held apart and in contact with the multi-point touch sensitive device (3) so as to no longer view the information about the data item.

2. The user interface unit as claimed in claim 1, wherein the gesture unit (13a) is configured such that the maximum allowable separation distance between the at least two fingers corresponds to the complete information available about the data item, and detecting the user stretching the at least two fingers apart in relation to the maximum allowable separation distance and holding on to the user interface unit allows viewing proportionate part of the information corresponding to the data item, the maximum allowable separation distance being determined based on the size of the user interface unit.

3. The user interface unit as claimed in claim 2, wherein the gesture unit (13a) is further configured such that stretching the at least two fingers apart around 50% of the maximum allowable separation distance allows proportionate viewing of around 50% of the complete available information corresponding to the at least one selected item of data.

4. A method of providing a user interface unit to interpret signals from a multi-point touch sensitive device, the method comprising
enabling a user to touch at least one item of data using a finger and select the at least one item of data; and
allowing the user to hold at least two fingers in contact with the at least one selected item of data and stretch the two fingers apart to view information about the at least one selected item of data while the two fingers are held apart and in contact with the user interface unit and to no longer view the information about the selected item of data in response to releasing the at least two fingers held apart in contact with the user interface unit.

5. The method as claimed in claim 4, wherein the method is configured such such that the maximum allowable separation distance between the two fingers corresponds to the complete available information about the selected item of data and stretching the at least two fingers apart in relation to the maximum allowable separation distance and holding on to the user interface unit allows viewing proportionate part of the information corresponding to the at least one selected item of data, the maximum allowable separation distance being determined based on the size of the user interface unit.

6. A computer program comprising program code means for use in a user interface unit to interpret signals from a multi-point touch sensitive device, the user interface unit comprising a gesture unit, the program code means being configured to allow a programmable device to
enable a user to touch at least one item of data using a finger and select the at least one item of data, hold the at least two fingers in contact with the at least one selected item of data and stretch the two fingers apart to view information about the at least one selected item of data while the two fingers are held apart and in contact with the user interface unit and to no longer view the information about the selected item of data in response to releasing the at least two fingers held apart in contact with the user interface unit.
